(19) United States
(12) Patent Application Publication
(10) Pub. No.: US 2018/0004289 A1
(43) Pub. Date: Jan. 4, 2018

(54) VIDEO DISPLAY SYSTEM, VIDEO DISPLAY METHOD, VIDEO DISPLAY PROGRAM

(71) Applicant: FOVE, INC., San Mateo, CA (US)

(72) Inventors: Lochlainn Wilson, Tokyo (JP); Genki Sano, Tokyo (JP); Yamato Kaneko, Tokyo (JP)

(21) Appl. No.: 15/637,525

(22) Filed: Jun. 29, 2017

(30) Foreign Application Priority Data
Jul. 1, 2016 (JP) 2016-131912

(51) Int. Cl. G06F 3/01; G02B 27/01; G06K 9/00; G06K 9/20

(52) U.S. Cl. CPC G06F 3/013; G06K 9/2027; G02B 27/017; G06K 9/00604; G06K 9/0061

(57) ABSTRACT

A video display system that improves convenience of a user by displaying video in a state in which the video can be easily viewed by a user is provided. A video display system according to the present invention includes a video output unit that outputs a video, a gaze detection unit that detects a gaze direction of a user on the video output by the video output unit, a video generation unit that performs video processing so that the user recognizes the video in a predetermined area corresponding to the gaze direction detected by the gaze detection unit better than other areas in the video output by the video output unit, a gaze prediction unit that predicts moving direction of the gaze of the user when the video output by the video output unit is a moving picture, and an extension video generation unit that performs video processing so that, in addition to the video in the predetermined area, the user recognizes the video in a predicted area corresponding to the gaze direction predicted by the gaze prediction unit better than other areas when the video output by the video output unit is a moving picture.

### BACKGROUND OF THE INVENTION

### Field of the Invention

The present invention relates to a video display system, a video display method, and a video display program, and more particularly, to a video display system that allows a video to be displayed on a display while the video display system is worn by a user, a video display method, and a video display program.

### Description of Related Art

Conventionally, for a video display that displays a video on a display, a video display systems that allow a video to be displayed on a display while the video display system is worn by a user, such as a head mounted display or smart glasses, have been developed. Here, rendering for imaging information on an object or the like given as numerical data by calculation is performed on video data. Thus, hidden surface removal, shading, or the like can be performed in consideration of a position of a gaze point of a user, the number or positions of light sources, or a shape or material of an object.

For the head mounted display or the smart glasses, a technology of detecting a gaze of a user and specifying a portion on a display at which the user gazes from the detected gaze is being developed (for example, refer to “GOOGLE's PAY PER GAZE PATENT PAVES WAY FOR WEARABLE AD TECH,” URL (on Mar. 16, 2016) http://www.wired.com/insights/2013/09/how-googles-pay-per-gaze-patent-paves-the-way-for-wearable-ad-tech/)

### SUMMARY OF THE INVENTION

However, in “GOOGLE's PAY PER GAZE PATENT PAVES WAY FOR WEARABLE AD TECH,” when a video such as a moving picture is displayed, there is a high possibility that a gaze of a user also moves significantly. Therefore, if a video can be displayed in a state in which a user can more easily view the video, convenience for the user can be improved. Here, movement of a gaze of a user is sometimes accelerated according to a type or a scene of a video. In this case, due to processing of image data, image quality or visibility is decreased when resolution of an image on a gaze plot is low. Therefore, if visibility can be improved by predicting movement of a gaze and increasing the apparent resolution of a screen entirely or partially by rendering processing, discomfort of a user that occurs in terms of image quality or visibility can be reduced. Here, because a transmission amount or a processing amount of image data is increased by simply increasing resolution of an image, data is preferably as light as possible. Therefore, it is preferable that a predetermined area including a gaze portion of a user have high resolution and the remaining portion have low resolution to reduce a transmission amount of a processing amount of image data.

Therefore, it is an object of the present invention to provide a video display system, a video display method, and a video display program capable of improving user convenience by displaying a video in a state in which the video can be more easily viewed by a user when a video is displayed in the video display system in which a video is displayed on a display.

To achieve the above object, a video display system according to the present invention includes a video output unit that outputs a video, a gaze detection unit that detects a gaze direction of a user on the video output by the video output unit, a video generation unit that performs video processing so that the user recognizes the video in a predetermined area corresponding to the gaze direction detected by the gaze detection unit better than other areas in the video output by the video output unit, a gaze prediction unit that predicts moving direction of the gaze of the user when the video output by the video output unit is a moving picture, and an extended area video generation unit that performs video processing so that, in addition to the video in the predetermined area, the user recognizes the video in a predicted area corresponding to the gaze direction predicted by the gaze prediction unit better than other areas when the video output by the video output unit is a moving picture.

The extended area video generation unit may perform video processing so that the predicted area is located adjacent to the predetermined area, perform video processing so that the predicted area is located in a state in which the predicted area is partially shared with the predetermined area, perform video processing so that the predicted area is larger than an area based on a shape of the predetermined area, and perform video processing with the predetermined area and the predicted area as a single extended area.

The gaze prediction unit may predict the gaze of the user on the basis of video data corresponding to a moving body that the user recognizes in the video data of the video output by the video output unit or predict the gaze of the user on the basis of accumulated data that varies in past time-series with respect to the video output by the video output unit. Further, the gaze prediction unit may predict that the gaze of the user will move when a change amount of a brightness level in the video output by the video output unit is a predetermined value or larger.

The video output unit may be provided in a head mounted display that is worn on the head of the user.

According to the present invention, a video display method includes a video outputting step of outputting a video, a gaze detecting step of detecting a gaze direction of a user on the video output in the video outputting step, a video generating step of performing video processing so that the user recognizes the video in a predetermined area corresponding to the gaze direction detected in the gaze detecting step better than other areas in the video output in the video outputting step, a gaze predicting step of predicting a moving direction of the gaze of the user when the video output in the video outputting step is a moving picture, and an extended area video generating step of performing video processing so that, in addition to the video in the predetermined area, the user recognizes the video in a predicted area corresponding to the gaze direction predicted in the gaze predicting step better than other areas when the video output in the video outputting step is a moving picture.

According to an aspect of the present invention, a video display program allows a computer to execute a video outputting function of outputting a video, a gaze detecting function of detecting a gaze direction of a user on the video output by the video outputting function, a video generating function of performing video processing so that the user recognizes the video in a predetermined area corresponding to the gaze direction detected in the gaze detecting step better than other areas in the video output by the video outputting function, a gaze predicting function of predicting a moving direction of the gaze of the user when the video output in the video outputting step is a moving picture, and an extended area video generating function of performing video processing so that, in addition to the video in the predetermined area, the user recognizes the video in a predicted area corresponding to the gaze direction predicted by the gaze predicting function better than other areas when the video output by the video outputting function is a moving picture.

According to the present invention, user convenience can be improved by displaying a video in a state in which a user can more easily view the video.

### BRIEF DESCRIPTION OF THE DRAWINGS

FIG. 1 is an external view illustrating a state in which a user wears a head mounted display;

FIG. 2A is a perspective view schematically illustrating a video output unit of the head mounted display, and FIG. 2B is a side view schematically illustrating the video output unit of the head mounted display;

FIG. 3 is a block diagram of a configuration of a video display system;

FIG. 4A is an explanatory diagram for describing calibration for detecting a gaze direction, and FIG. 4B is a schematic diagram for describing position coordinates of a cornea of a user;

FIG. 5 is a flowchart illustrating an operation of the video display system;

FIG. 6A is an explanatory diagram of a video display example before video processing displayed by the video display system, and FIG. 6B is an explanatory diagram of a video display example in a gaze detecting state displayed by the video display system;

FIG. 7A is an explanatory diagram of a video display example in a video processing state displayed by the video display system, FIG. 7B is an explanatory diagram of an extended area in a state in which a part of a predetermined area and a part of a predicted area are made to overlap each other, FIG. 7C is an explanatory diagram of a state in which a predetermined area and a predicted area form a single extended area, FIG. 7D is an explanatory diagram of an extended area in a state in which a predicted area of a different shape is made to be adjacent to an outside of a predetermined area, and FIG. 7E is an explanatory diagram of an extended area in which a predicted area is made adjacent to a predetermined area without overlapping the predetermined area;

FIG. 8 is an explanatory diagram from downloading video data to displaying the video data on a screen; and

FIG. 9 is a block diagram illustrating a circuit configuration of the video display system.

### DETAILED DESCRIPTION OF THE INVENTION

Next, a video display system according to an embodiment of the present invention will be described with reference to the drawings. The embodiment described below is a suitable specific example in the video display system of the present invention, and although various technically preferable limitations may be added in some cases, the technical scope of the present invention is not limited to such aspects unless particularly so described. Elements in the embodiment described below can be appropriately replaced with existing elements and the like, and various variations including combinations with other existing elements are possible. Therefore, the content of the invention described in the claims is not limited by the description of the embodiments described below.

Further, although a case in which the present invention is applied to a head mounted display as a video display for displaying a video to a user while being worn by the user will be described in the embodiment described below, the present invention is not limited thereto and may also be applied to smart glasses, or the like.

### <Configuration>

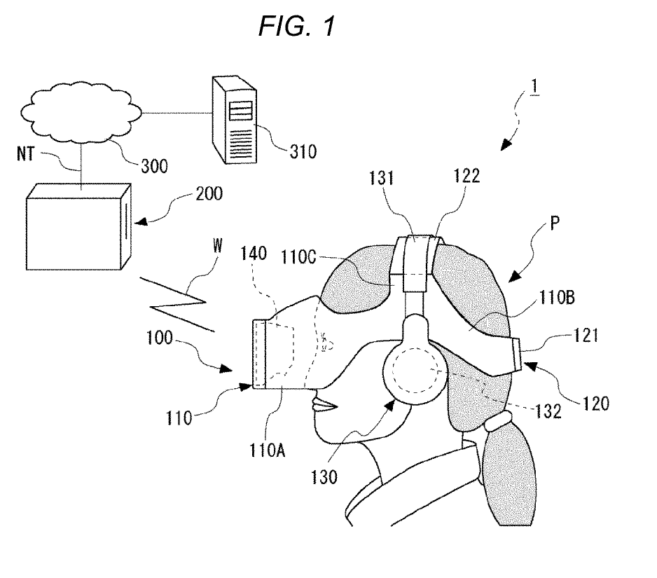

In FIG. 1, a video display system 1 includes a head mounted display 1 capable of outputting a video and a sound while mounted on the head of a user P and a gaze detection device 200 for detecting a gaze of the user P. The head mounted display 100 and the gaze detection device 200 can communicate with each other via an electric communication line. Although the head mounted display 100 and the gaze detection device 200 are connected via a wireless communication line W in the example illustrated in FIG. 1, the head mounted display 100 and the gaze detection device 200 may also be connected via a wired communication line. The connection between the head mounted display 100 and the gaze detection device 200 via the wireless communication line W can be realized using known short-range wireless communication, e.g., a wireless communication technique such as Wi-Fi (registered trademark) or Bluetooth (registered trademark).

Although FIG. 1 illustrates an example in which the head mounted display 100 and the gaze detection device 200 are different devices, the gaze detection device 200 may be built into the head mounted display 100.

The gaze detection device 200 detects a gaze direction of at least one of a right eye and a left eye of the user P wearing the head mounted display 100 and specifies a focal point of the user P. That is, the gaze detection device 200 specifies a position at which the user P gazes on a two-dimensional (2D) video or a three-dimensional (3D) video displayed by the head mounted display 100. The gaze detection device 200 also functions as a video generation device that generates a 2D video or a 3D video to be displayed by the head mounted display 100.

For example, the gaze detection device 200 is a device capable of reproducing videos of stationary game machines, portable game machines, PCs, tablets, smartphones, phablets, video players, TVs, or the like, but the present invention is not limited thereto. Here, transfer of videos between the head mounted display 100 and the gaze detection device 200 is executed according to a standard such as Miracast (registered trademark), WiGig (registered trademark), or Wireless Home Digital Interface (WHDI (registered trademark)), but the present invention is not limited thereto. Other electric communication line technologies may be used. For example, a sound wave communication technology or an optical transmission technology may be used. The gaze detection device 200 may download video data (moving picture data) from a server 310 via the internet (a cloud 300) through an electric communication line NT such as an internet communication line.

The head mounted display 100 includes a main body portion 110, a mounting portion 120, and headphones 130.

The main body portion 110 is integrally formed of resin or the like to include a housing portion 110A, wing portions 110B extending from the housing portion 110A to the left and right rear of the user P in a mounted state, and flange portions 110C rising above the user P from middle portions of each of the left and right wing portions 110B. The wing portions 110B and the flange portions 110C are curved to approach each other toward a distal end side.

The housing portion 110A contains a wireless transfer module such as Wi-Fi (registered trademark) or Bluetooth (registered trademark) (not illustrated) for short-range wireless communication, in addition to a video output unit 140 for presenting a video to the user P. The housing portion 110A is arranged at a position at which an entire portion around both eyes of the user P (about the upper half of the face) is covered when the user P is wearing the head mounted display 100. Thus, when the user P wears the head mounted display 100, the main body portion 110 blocks a field of view of the user P.

The mounting portion 120 stabilizes the head mounted display 100 on the head of the user P when the user P wears the head mounted display 100 on his or her head. The mounting portion 120 can be realized by, for example, a belt or an elastic band. In the example illustrated in FIG. 1, the mounting portion 120 includes a rear mounting portion 121 that supports the head mounted display 100 to surround a portion near the back of the head of the user P across the left and right wing portions 110B, and an upper mounting portion 122 that supports the head mounted display 100 to surround a portion near the top of the head of the user P across the left and right flange portions 110C. Thus, the mounting portion 120 can stably mount the head mounted display 100 regardless of the size of the head of the user P. In the example illustrated in FIG. 1, although a configuration in which support is provided at the top of the head of the user P by the flange portions 110C and the upper mounting portion 122 is adopted because a general-purpose product is used as the headphones 130, a headband 131 of the headphones 130 may be detachably attached to the wing portions 110B by an attachment method, and the flange portions 110C and the upper mounting portion 122 may be eliminated.

The headphones 130 output sound of a video reproduced by the gaze detection device 200 from a sound output unit (speaker) 132. The headphones 130 may not be fixed to the head mounted display 100. Thus, even when the user P is wearing the head mounted display 100 using the mounting portion 120, the user P can freely attach and detach the headphones 130. Here, the headphones 130 may directly receive sound data from the gaze detection device 200 via the wireless communication line W or may indirectly receive sound data from the head mounted display 100 via a wireless or wired electric communication line.

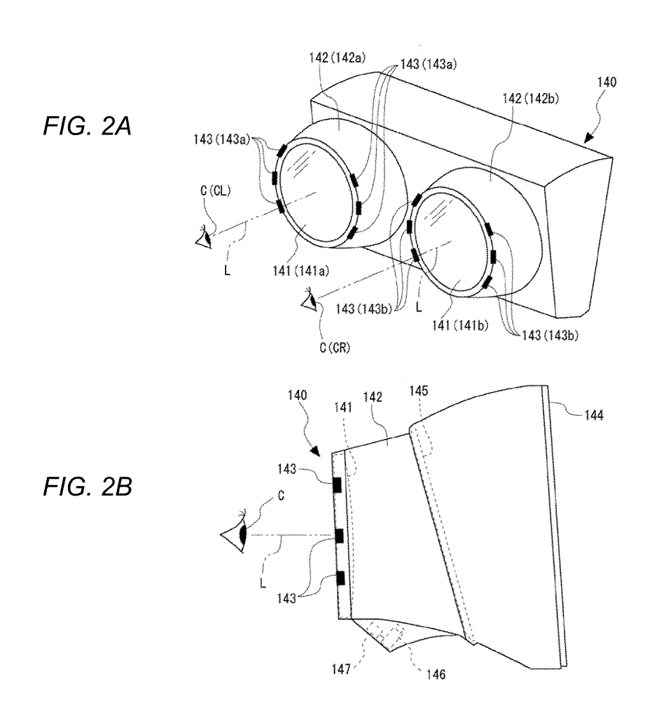

As illustrated in FIG. 2, the video output unit 140 includes convex lenses 141, lens holders 142, light sources 143, a display 144, a wavelength control member 145, a camera 146, and a first communication unit 147.

As illustrated in FIG. 2(A), the convex lenses 141 include a convex lens 141a for the left eye and a convex lens 141b for the right eye facing anterior eye parts of both eyes including a cornea C of the user P in the main body portion 110 when the user P is wearing the head mounted display 100.

In the example illustrated in FIG. 2(A), the convex lens 141a for the left eye is arranged to face a cornea CL of the left eye of the user P when the user P is wearing the head mounted display 100. Similarly, the convex lens 141b for the right eye is arranged to face a cornea CR of the right eye of the user P when the user P is wearing the head mounted display 100. The convex lens 141a for the left eye and the convex lens 141b for the right eye are supported by a lens holder 142a for the left eye and a lens holder 142b for the right eye of the lens holders 142, respectively.

The convex lenses 141 are disposed on the opposite side of the display 144 with respect to the wavelength control member 145. In other words, the convex lenses 141 are arranged to be located between the wavelength control member 145 and the corneas C of the user P when the user P is wearing the head mounted display 100. That is, the convex lenses 141 are disposed at positions facing the corneas C of the user P when the user is wearing the head mounted display 100.

The convex lenses 141 condense video display light that is transmitted through the wavelength control member 145 from the display 144 toward the user P. Thus, the convex lenses 141 function as video magnifiers that enlarge a video generated by the display 144 and presents the video to the user P. Although only single convex lens 141 is illustrated for the left and right convex lenses in FIG. 2 for convenience of description, the convex lenses 144 may be lens groups configured by combining various lenses or may be a plano-convex lens in which one surface has curvature and the other surface is flat.

In the following description, the cornea CL of the left eye of the user P and the cornea CR of the right eye of the user P are simply referred to as a “cornea C” unless the corneas are particularly distinguished. The convex lens 141a for the left eye and the convex lens 141b for the right eye are simply referred to as a “convex lens 141” unless the two lenses are particularly distinguished. The lens holder 142a for the left eye and the lens holder 142b for the right eye are referred to as a “lens holder 142” unless the holders are particularly distinguished.

The light sources 143 are disposed near an end face of the lens holder 142 and along the periphery of the convex lens 141 and emits near-infrared light as illumination light including invisible light. The light sources 143 include a plurality of light sources 143a for the left eye of the user P and a plurality of light sources 143b for the right eye of the user P. In the following description, the light sources 143a for the left eye of the user P and the light sources 143b for the right eye of the user P are simply referred to as a “light source 143” unless the light sources are particularly distinguished. In the example illustrated in FIG. 2A, six light sources 143a are arranged in the lens holder 142a for the left eye. Similarly, six light sources 143b are arranged in the lens holder 142b for the right eye. In this way, by arranging the light source 143 at the lens holder 142 that grips the convex lens 141 instead of directly arranging the light source 143 at the convex lens 141, attachment of the convex lens 141 and the light source 143 to the lens holder 142 is facilitated. This is because machining for attaching the light source 143 is easier than for the convex lenses 141 that are made of glass or the like because the lens holder 142 is generally made of a resin or the like.

As described above, the light source 143 is arranged in the lens holder 142 which is a member for gripping the convex lens 141. Therefore, the light source 143 is arranged along the periphery of the convex lens 141 provided in the lens holder 142. In this case, although the number of the light sources 143 that irradiate each eye of the user P with the near-infrared light is six, the number of the light sources 143 is not limited thereto. There may be at least one light source 143 for each eye, and two or more light sources 103 are preferable. When four or more light sources 143 (particularly, an even number) are arranged, it is preferable that the light sources 143 be symmetrically arranged in up-down and left-right directions with respect to the user P orthogonal to a lens optical axis L passing through the center of the convex lens 141. Also, it is preferable that the lens optical axis L be coaxial with a visual axis passing through vertexes of the corneas of the left and right eyes of the user P.

The light source 143 can be realized by using a light emitting diode (LED) or a laser diode (LD) capable of emitting light in a near-infrared wavelength region. The light source 143 emits the near-infrared light beam (parallel light). Here, although most of the light source 143 is a parallel light flux, a part of the light flux is diffused light. The near-infrared light emitted by the light source 143 does not have to be converted into parallel light by using a mask, an aperture, a collimating lens, or other optical members, and the whole light flux may be used as it is as illumination light.

Near-infrared light is generally light having a wavelength in the near-infrared region of the invisible light region which cannot be visually recognized by the naked eye of the user P. Although the specific wavelength standard in the near-infrared region varies by country and with various organizations, in the present embodiment, wavelengths in the vicinity of the near-infrared region close to the visible light region (for example, around 700 nm) are used. A wavelength that is received by the camera 146 and does not place a burden on the eyes of the user P is used as the wavelength of near-infrared light emitted from the light source 143. For example, if the light emitted from the light source 143 is visually recognized by the user P, because the light may hinder visibility of a video displayed on the display 144, the light preferably has a wavelength that is not visually recognized by the user P. Therefore, the invisible light in the claims is not specifically limited on the basis of strict criteria which vary depending on individual differences and countries. That is, on the basis of the usage form described above, the invisible light may include wavelengths closer to the visible light region than 700 nm (e.g., 650 nm to 700 nm) which cannot be visually recognized by the user P or are considered difficult to be visually recognized by the user P.

The display 144 displays images to be presented to the user P. A video displayed by the display 144 is generated by a video generation unit 214 of the gaze detection device 200 which will be described below. The display 144 can be realized by using an existing liquid crystal display (LCD), organic electro luminescence display (organic EL display), or the like. Thus, for example, the display 144 functions as a video output unit that outputs a video based on moving picture data downloaded from the server 310 on various sites of the cloud 300. Therefore, the headphones 130 function as sound output units that output sound corresponding to various videos in time series. Here, the moving picture data may be sequentially downloaded from the server 310 and displayed or may also be reproduced after being temporarily stored in various storage media.

When the user P is wearing the head mounted display 100, the wavelength control member 145 is arranged between the display 144 and the cornea C of the user P. An optical member that transmits a light flux having a wavelength in the visible light region displayed by the display 144 and reflects a light flux having a wavelength in the invisible light region may be used as the wavelength control member 145. An optical filter, a hot mirror, a dichroic mirror, a beam splitter, or the like may also be used as the wavelength control member 145 as long as the optical filter, the hot mirror, the dichroic mirror, the beam splitter, or the like has a characteristic of transmitting visible light and reflecting invisible light. Specifically, the wavelength control member 145 reflects near-infrared light emitted from the light source 143 and transmits visible light, which is a video displayed by the display 144.

Although not illustrated, the video output unit 140 has a total of two displays 144 on the left and right sides of the user P and may independently generate a video to be presented to the right eye of the user P and a video to be presented to the left eye of the user P. Thus, the head mounted display 100 can present a parallax image for the right eye and a parallax image for the left eye to the right eye and the left eye of the user P, respectively. In this way, the head mounted display 100 can present a stereoscopic image (3D image) with a sense of depth to the user P.

As described above, the wavelength control member 145 transmits visible light and reflects near-infrared light. Therefore, the light flux in the visible light region based on the video displayed by the display 144 passes through the wavelength control member 145 and reaches the cornea C of the user P. Further, of the near-infrared light emitted from the light source 143, most of the above-described parallel light flux is formed in a spot shape (beam shape) to form a bright spot image in an anterior eye part of the user P, reaches the anterior eye part, is reflected from the anterior eye part of the user P, and reaches the convex lens 141. Of the near-infrared light emitted from the light source 143, the diffused light flux is diffused to form an entire anterior eye part image in the anterior eye part of the user P, reaches the anterior eye part, is reflected from the anterior eye part of the user P, and reaches the convex lens 141. The reflected light flux for the bright spot image that is reflected from the anterior eye part of the user P and reaches the convex lens 141 passes through the convex lens 141, is reflected by the wavelength control member 145, and is received by the camera 146. Similarly, the reflected light flux for the anterior eye part image that is reflected from the anterior eye part of the user P and reaches the convex lens 141 passes through the convex lens 141, is reflected by the wavelength control member 145, and is received by the camera 146.

The camera 146 includes a cut-off filter (not illustrated) that blocks visible light and captures near-infrared light reflected from the wavelength control member 145. That is, the camera 146 may be realized by an infrared camera capable of capturing the bright spot image of near-infrared light emitted from the light source 143 and reflected from the anterior eye part of the user P and capturing the anterior eye part image of the near-infrared light reflected from the anterior eye part of the user P.

As an image captured by the camera 146, the bright spot image based on the near-infrared light reflected from the cornea C of the user P and the anterior eye part image including the cornea C of the user P observed in the near-infrared wavelength region are captured. Therefore, while a video is being displayed by the display 144, the camera 146 may acquire the bright spot image and the anterior eye part image by turning on the light source 143 as an illumination light at all times or at regular intervals. In this way, a camera for detecting a gaze that changes in a time series of the user P caused by a change in a video being displayed on the display 144 may be used as the camera 146.

Although not illustrated, there are two cameras 146, i.e., a camera 146 for the right eye that captures an image of the near-infrared light reflected from the anterior eye part including the surroundings of the cornea CR of the right eye of the user P, and a camera 146 for the left eye that captures an image including the near-infrared light reflected from the anterior eye part including the surrounding of the cornea CL of the left eye of the user P. In this way, an image for detecting gaze directions of both the right eye and the left eye of the user P can be acquired.

The image data based on the bright spot image and the anterior eye part image captured by the camera 146 is output to the gaze detection device 200 for detecting a gaze direction of the user P. Although a gaze direction detection function of the gaze detection device 200 will be described in detail below, the gaze direction detection function is realized by a video display program executed by a central processing unit (CPU) of the gaze detection device 200. Here, when the head mounted display 100 has a calculation resource (function as a computer) such as the CPU or a memory, the CPU of the head mounted display 100 may execute a program for realizing the gaze direction detection function.

Although the configuration for presenting a video mostly to the left eye of the user P in the video output unit 140 has been described above, the configuration for presenting the video to the right eye of the user P is the same as above except that parallax is required to be taken into consideration when a stereoscopic video is being presented

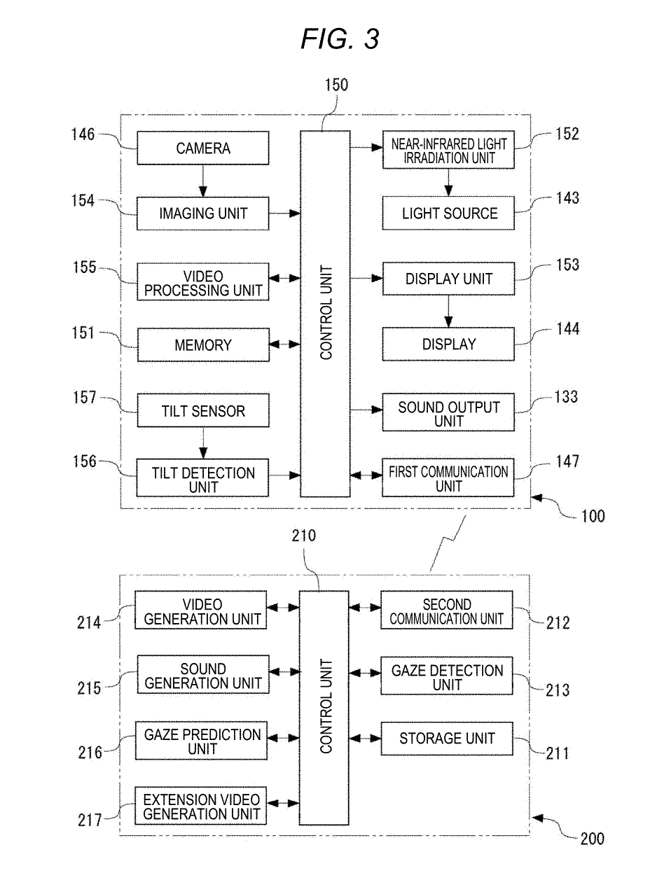

FIG. 3 is a block diagram of the head mounted display 100 and the gaze detection device 200 according to the video display system 1.

In addition to the light source 143, the display 144, the camera 146, and the first communication unit 147, the head mounted display 100 includes a control unit (CPU) 150, a memory 151, a near-infrared light irradiation unit 152, a display unit 153, an imaging unit 154, an image processing unit 155, and a tilt detection unit 156 as electric circuit parts.

The gaze detection device 200 includes a control unit (CPU) 210, a storage unit 211, a second communication unit 212, a gaze detection unit 213, a video generation unit 214, a sound generation unit 215, a gaze prediction unit 216, and an extension video generation unit 217.

The first communication unit 147 is a communication interface having a function of communicating with the second communication unit 212 of the gaze detection device 200. The first communication unit 147 communicates with the second communication unit 212 through wired or wireless communication. Examples of usable communication standards are as described above. The first communication unit 147 transmits video data to be used for gaze detection transferred from the imaging unit 154 or the image processing unit 155 to the second communication unit 212. The first communication unit 147 transmits image data based on the bright spot image and the anterior eye part image captured by the camera 146 to the second communication unit 212. Further, the first communication unit 147 transfers video data or a marker image transmitted from the gaze detection device 200 to the display unit 153. The video data transmitted from the gaze detection device 200 is data for displaying a moving picture including a video of a moving person or object as an example. The video data may also be a pair of parallax videos including a parallax video for the right eye and a parallax image for the left eye for displaying a 3D video.

The control unit 150 controls the above-described electric circuit parts according to the program stored in the memory 151. Therefore, the control unit 150 of the head mounted display 100 may execute the program realizing the gaze direction detection function according to the program stored in the memory 151.

In addition to storing a program for causing the above-described head mounted display 100 to function, the memory 151 may temporarily store image data and the like captured by the camera 146 as needed.

The near-infrared light irradiation unit 152 controls the lighting state of the light source 143 and emits near-infrared light from the light source 143 to the right eye or the left eye of the user P.

The display unit 153 has a function of displaying the video data transmitted by the first communication unit 147 on the display 144. The display unit 153 displays, for example, video data such as various moving pictures downloaded from video sites in the cloud 300, video data such as games downloaded from game sites in the cloud 300, and various video data such as videos, game videos, and picture videos reproduced by a storage reproduction device (not illustrated) firstly connected to the gaze detection device 200. Further, the display unit 153 displays a marker image output by the video generation unit 214 on designated coordinates of the display unit 153.

Using the camera 146, the imaging unit 154 captures an image including near-infrared light reflected by the left and right eyes of the user P. Further, the imaging unit 154 captures the bright spot image and the anterior eye part image of the user P gazing at the marker image displayed on the display 144, which will be described below. The imaging unit 154 transfers the captured image data to the first communication unit 147 or the image processing unit 155.

The image processing unit 155 performs image processing on the image captured by the imaging unit 154 as needed and transfers the processed image to the first communication unit 147.

The tilt detection unit 156 calculates a tilt of the head of the user P as a tilt of the head mounted display 100 on the basis of a detection signal from a tilt sensor 157 such as an acceleration sensor or a gyro sensor. The tilt detection unit 156 sequentially calculates the tilt of the head mounted display 100 and transmits tilt information which is the calculation result to the first communication unit 147.

The control unit (CPU) 210 executes the above-described gaze detection by the program stored in the storage unit 211. The control unit 210 controls the second communication unit 212, the gaze detection unit 213, the video generation unit 214, the sound generation unit 215, the gaze prediction unit 216, and the extension video generation unit 217 according to the program stored in the storage unit 211.

The storage unit 211 is a recording medium that stores various programs and data required for operation of the gaze detection device 200. The storage unit 211 can be realized by, for example, a hard disk drive (HDD), a solid state drive (SSD), etc. The storage unit 211 stores position information on a screen of the display 144 corresponding to each character in a video corresponding to the video data or sound information of each of the characters.

The second communication unit 212 is a communication interface having a function of communicating with the first communication unit 147 of the head mounted display 100. As described above, the second communication unit 212 communicates with the first communication unit 147 through wired communication or wireless communication. The second communication unit 212 transmits video data for displaying a video including an image in which movement of a character transferred by the video generation unit 214 is present or a marker image used for calibration to the head mounted display 100. Further, the second communication unit 212 transfers a bright spot image of the user P gazing at the marker image captured by the imaging unit 154 transferred from the head mounted display 100, an anterior eye part image of the user P viewing a video displayed on the basis of the video data output by the video generation unit 214, and the tilt information calculated by the tilt detection unit 156 to the gaze detection unit 213. Further, the second communication unit 212 may access an external network (e.g., the Internet), acquire video information of a moving picture website designated by the video generation unit 214, and transfer the video information to the video generation unit 214. Further, the second communication unit 212 may transmit sound information transferred by the sound generation unit 215 to the headphones 130 directly or via the first communication unit 147.

The gaze detection unit 213 analyzes the anterior eye part image captured by the camera 146 and detects a gaze direction of the user P. Specifically, the gaze detection unit 213 receives video data for gaze detection of the right eye of the user P from the second communication unit 212 and detects a gaze direction of the right eye of the user P. The gaze detection unit 213 calculates a right-eye gaze vector indicating the gaze direction of the right eye of the user P by using a method which will be described below. Likewise, the gaze detection unit 213 receives the video data for gaze detection of the left eye of the user P from the second communication unit 212 and calculates a left-eye gaze vector indicating the gaze direction of the left eye of the user P. Then, the gaze detection unit 213 uses the calculated gaze vectors to specify a point gazed at by the user P in the video displayed on the display unit 153. The gaze detection unit 213 transfers the specified gaze point to the video generation unit 214.

The video generation unit 214 generates video data to be displayed on the display unit 153 of the head mounted display 100 and transfers the video data to the second communication unit 212. The video generation unit 214 generates a marker image for calibration for gaze detection and transfers the marker image together with positions of display coordinates thereof to the second communication unit 212 to transmit the marker image to the head mounted display 100. Further, the video generation unit 214 generates video data with a changed form of video display according to the gaze direction of the user P detected by the gaze detection unit 213. A method of changing a video display form will be described in detail below. The video generation unit 214 determines whether the user P is gazing at a specific moving person or object (hereinafter, simply referred to as a “character”) on the basis of the gaze point transferred by the gaze detection unit 213 and, when the user P is gazing at a specific character, specifies the character.

On the basis of the gaze direction of the user P, the video generation unit 214 may generate video data so that a video in a predetermined area including at least a part of the specific character can be more easily gazed at than the video in areas other than the predetermined area. For example, emphasizing such as sharpening the video in the predetermined area while blurring the areas other than the predetermined area or generating smoke in the areas is possible. Also, the video in the predetermined area may not be sharpened and may have original resolution. Also, according to types of videos, additional functions such as moving a specific character to be located at the center of the display 144, zooming up the specific character, or tracking the specific character when the specific character is moving may be given. Sharpening of a video (hereinafter, also referred to as “sharpening processing”) is not simply increasing resolution and is not limited thereto as long as visibility can be improved by increasing apparent resolution of an image including a current gaze direction of the user and a predicted gaze direction which will be described below. That is, if the resolution of the other areas is decreased while the resolution of the video in the predetermined area is kept unchanged, the apparent resolution is increased from the viewpoint of the user. Also, in adjustment as the sharpening processing, a frame rate, which is the number of frames processed per unit time, may be adjusted, or a compressed bit rate of image data, which is the number of bits of data being processed or transferred per unit time, may be adjusted. In this way, because the apparent resolution can be increased (decreased) for the user while the data transmission amount is light, the video in the predetermined area can be sharpened. Further, in the data transmission, the video data corresponding to the video in the predetermined area and the video data corresponding to the video in areas other than the predetermined area may be separately transferred and then synthesized or may be synthesized in advance and then transferred.

The sound generation unit 215 generates sound data so that sound data corresponding to the video data in time series is output from the headphones 130.

The gaze prediction unit 216 predicts how the character specified by the gaze detection unit 213 moves on the display 144 on the basis of the video data. Further, the gaze prediction unit 216 may predict a gaze of the user P on the basis of video data corresponding to a moving body (the specific character) that the user P recognizes in the video data of the video output on the display 144 or predict a gaze of the user P on the basis of accumulated data that varies in past time-series with respect to the video output by the display 144. Here, the accumulated data is data in which video data that varies in time series and gaze positions (X-Y coordinates) are associated in a table manner. The accumulated data may be, for example, fed back to the respective sites of the cloud 300 and may be simultaneously downloaded with video data. When the same user P views the same video, because it is highly likely that the user P views the same scenes, data in which video data that varies in time series before the previous time and gaze positions (X-Y coordinates) are associated in a table manner may be stored in the storage unit 211 or the memory 151.

When the video output by the display 144 is a moving picture, the extension video generation unit 217 performs video processing so that, in addition to the video in the predetermined area, the user P recognizes the video in a predicted area corresponding to the gaze direction predicted by the gaze prediction unit 216 better (more easily) than other areas when the video output by the display 144 is a moving picture. Further, an extended area by the predetermined area and the predicted area will be described in detail below.

Next, gaze direction detection according to the embodiment will be described.

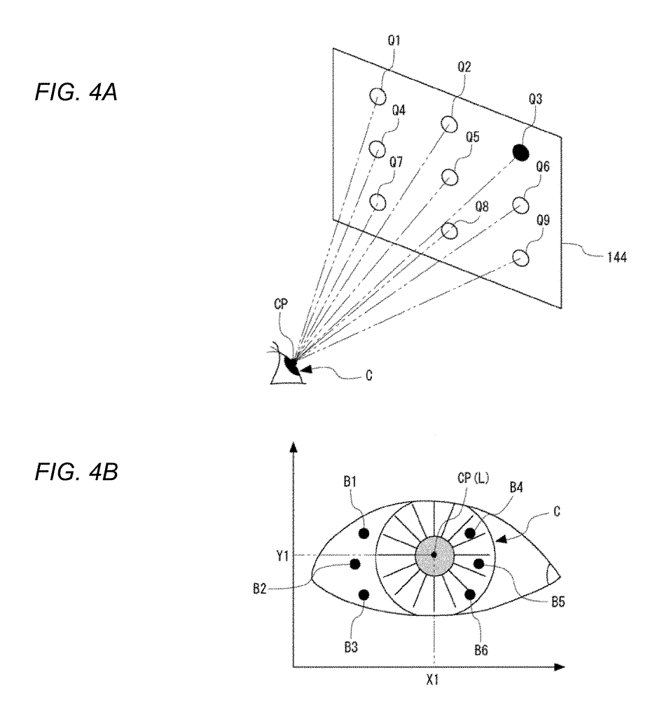

FIG. 4 is a schematic diagram for describing calibration for gaze direction detection according to the embodiment. The gaze direction of the user P may be realized by the gaze detection unit 213 in the gaze detection device 200 analyzing a video captured by the imaging unit 154 and output to the gaze detection device 200 by the first communication unit 147.

The video generation unit 214, for example, generates nine points (marker images) including points Q₁ to Q₉ as illustrated in FIG. 4(A), and causes the points to be displayed by the display 144 of the head mounted display 100. Here, the video generation unit 214, for example, causes the user P to sequentially gaze at the points Q₁ up to Q₉. In this case, the user P is requested to gaze at each of the points Q₁ to Q₉ by moving only his or her eyeballs as possible without moving his or her neck or head. The camera 146 captures an anterior eye part image and a bright spot image including the cornea C of the user P when the user P is gazing at the nine points Q₁ to Q₉.

As illustrated in FIG. 4(B), the gaze detection unit 213 analyzes the anterior eye part image including the bright spot image captured by the camera 146 and detects each bright spot image originating from near-infrared light. When the user P gazes at each point by moving only his or her eyeballs, positions of bright spots B1 to B6 are considered to be stationary even when the user P is gazing at any one of points Q₁ to Q₉. Therefore, the gaze detection unit 213 sets a 2D coordinate system with respect to the anterior eye part image captured by the imaging unit 154 on the basis of the detected bright spots B1 to B6.

Further, the gaze detection unit 213 detects a vertex CP of the cornea C of the user P by analyzing the anterior eye part image captured by the imaging unit 154. This is realized by using known image processing such as the Hough transform or an edge extraction process. Accordingly, the gaze detection unit 213 can acquire the coordinates of the vertex CP of the cornea C of the user P in the set 2D coordinate system.

In FIG. 4(A), the coordinates of the points Q₁ to Q₉ in the 2D coordinate system set on the display screen of the display 144 are Q₁(x1, y1)^{T}, Q₂(x2, y2)^{T}, Q₉(x9, y9)^{T}, respectively. The coordinates are, for example, a number of a pixel located at a center of each of the points Q₁ to Q₉. Further, the vertex CP of the cornea C of the user P when the user P gazes at the points Q1 to Q9 are labeled P₁ to P₉. In this case, the coordinates of the points P1 to P9 in the 2D coordinate system are P₁(X1, Y1)^{T}, P₂(X2, Y2)^{T}, P₉(X9, Y9)^{T}. T represents a transposition of a vector or a matrix.

A matrix M with a size of 2×2 is defined as Equation (1) below.

$$M = ( \begin{matrix}{m}_{11} & {m}_{12} \\ {m}_{21} & {m}_{22}\end{matrix} ) \qquad ( 1 )$$

In this case, if the matrix M satisfies Equation (2) below, the matrix M is a matrix for projecting the gaze direction of the user P onto a display screen of the display 144.

P_{N}=MQ_{N} (N=1, . . . , 9) (2)

When Equation (2) is written specifically, Equation (3) below is obtained.

$$( \begin{matrix}{x}_{1} & {x}_{2} & … & {x}_{9} \\ {y}_{1} & {y}_{2} & … & {y}_{9}\end{matrix} ) = ( \begin{matrix}{m}_{11} & {m}_{12} \\ {m}_{21} & {m}_{22}\end{matrix} ) ( \begin{matrix}{X}_{1} & {X}_{2} & … & {X}_{9} \\ {Y}_{1} & {Y}_{2} & … & {Y}_{9}\end{matrix} ) \qquad ( 3 )$$

By transforming Equation (3), Equation (4) below is obtained.

$$\begin{matrix}( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) ( \begin{matrix}{m}_{11} \\ {m}_{12} \\ {m}_{21} \\ {m}_{22}\end{matrix} ) & ( 4 ) \\ Here , & \\ y = ( \begin{matrix}{x}_{1} \\ {x}_{2} \\ ⋮ \\ {x}_{9} \\ {y}_{1} \\ {y}_{2} \\ ⋮ \\ {y}_{9}\end{matrix} ) , A = ( \begin{matrix}{X}_{1} & {Y}_{1} & 0 & 0 \\ {X}_{2} & {Y}_{2} & 0 & 0 \\ ⋮ & ⋮ & ⋮ & ⋮ \\ {X}_{9} & {Y}_{9} & 0 & 0 \\ 0 & 0 & {X}_{1} & {Y}_{1} \\ 0 & 0 & {X}_{2} & {Y}_{2} \\ ⋮ & ⋮ & ⋮ & ⋮ \\ 0 & 0 & {X}_{9} & {Y}_{9}\end{matrix} ) , x = ( \begin{matrix}{m}_{11} \\ {m}_{12} \\ {m}_{21} \\ {m}_{22}\end{matrix} ) & \end{matrix}$$

By the above, Equation (5) below is obtained.

y=Ax (5)

In Equation (5), elements of the vector y are known since these are coordinates of the points Q₁ to Q₉ that are displayed on the display 144 by the gaze detection unit 213. Further, the elements of the matrix A can be acquired since the elements are coordinates of the vertex CP of the cornea C of the user P. Thus, the gaze detection unit 213 can acquire the vector y and the matrix A. A vector x that is a vector in which elements of a transformation matrix M are arranged is unknown. Since the vector y and matrix A are known, an issue of estimating matrix M becomes an issue of obtaining the unknown vector x.

Equation (5) becomes the main issue to decide if the number of equations (that is, the number of points Q presented to the user P by the gaze detection unit 213 at the time of calibration) is larger than the number of unknown numbers (that is, the number 4 of elements of the vector x). Since the number of equations is nine in the example illustrated in Equation (5), Equation (5) is the main issue to decide.

An error vector between the vector y and the vector Ax is defined as vector e. That is, e=y−Ax. In this case, a vector xₒₚₜ that is optimal in the sense of minimizing the sum of squares of the elements of the vector e can be obtained from Equation (6) below.

xₒₚₜ=(A_{T}A)₋₁A_{T}y (6)

Here, “−1” indicates an inverse matrix.

The gaze detection unit 213 forms the matrix M of Equation (1) by using the elements of the obtained vector xₒₚₜ. Accordingly, by using coordinates of the vertex CP of the cornea C of the user P and the matrix M, the gaze detection unit 213 may estimate which portion of the video displayed on the display 144 the right eye of the user P is viewing according to Equation (2). Here, the gaze detection unit 213 also receives information on a distance between the eye of the user P and the display 144 from the head mounted display 100 and modifies the estimated coordinate values of the gaze of the user P according to the distance information. The deviation in estimation of the gaze position due to the distance between the eye of the user P and the display 144 may be ignored as an error range. Accordingly, the gaze detection unit 213 can calculate a right gaze vector that connects a gaze point of the right eye on the display 144 to a vertex of the cornea of the right eye of the user P. Similarly, the gaze detection unit 213 can calculate a left gaze vector that connects a gaze point of the left eye on the display 144 to a vertex of the cornea of the left eye of the user P. A gaze point of the user P on a 2D plane can be specified with a gaze vector of only one eye, and information on a depth direction of the gaze point of the user P can be calculated by obtaining gaze vectors of both eyes. In this manner, the gaze detection device 200 may specify a gaze point of the user P. The method of specifying a gaze point described herein is merely an example, and a gaze point of the user P may be specified using methods other than that according to this embodiment.

### <Video Data>

Here, specific video data will be described. For example, in a moving picture of a car race, it is possible to specify a course corresponding to the video data according to an installation position of the camera on the course. Also, because a machine (a racing car) traveling on the course basically travels on the course, the traveling route can be specified (predicted) to a certain extent. Further, although multiple machines are traveling on the course during the race, a machine can be specified by a machine number or coloring.

In the video, the audience in their seats are also moving. However, from the viewpoint of a moving picture of a race, because the user is a moving body that is rarely recognized due to the purpose of watching the race, the audience can be excluded from moving bodies that the user P recognizes and for which gaze prediction is performed. Accordingly, it is possible to predict, for each machine traveling on each course displayed on the display 144, to what extent a movement is being performed. Also, a “moving body that the user P recognizes” refers to a moving body that is moving in the video and is consciously recognized by the user P. In other words, in the claims, a “moving body that a user recognizes” refers to a person or object which is moving in a video and may be an object of gaze detection and gaze prediction.

In edited video data of a car race which is not a real-time video, it is possible to associate each machine with a position of the display 144 in a time series, including whether each of the machines is displayed on the display 144, in a table manner. Accordingly, it is possible to specify which machine the user P is viewing as a specific character, and it is also possible to specify how the specified machine will move, instead of mere prediction.

Further, the shape or size of a predetermined area which will be described below may also be changed according to a traveling position (perspective) of each machine.

A moving picture of a car race is merely an example of video data, and in a moving picture of a game, game characters may be specified or a predetermined area may be set according to types of games. Here, for example, when an entire video is desired to be uniformly displayed according to types or scenes of battle games, or in cases of games such as Go or Shogi or a classical concert, even when a video contains certain movement, the video may not be included in a moving picture for gaze prediction.

### <Operation>

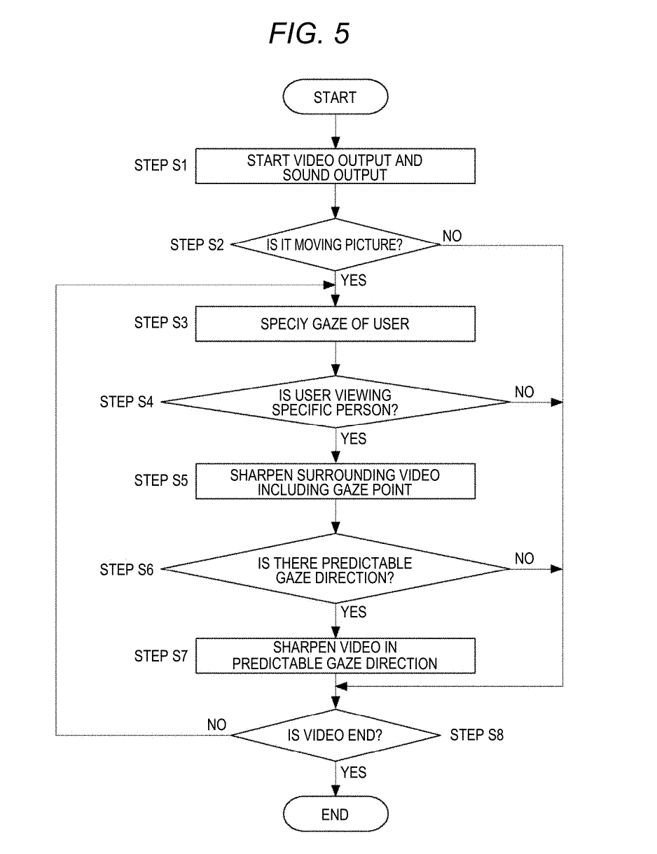

Next, an operation of the video display system 1 will be described on the basis of the flowchart in FIG. 5. In the description below, it is described that the control unit 210 of the gaze detection device 200 transmits video data including sound data from the second communication unit 212 to the first communication unit 147.

### (Step S1)

In step S1, the control unit 150 operates the display unit 153 and the sound output unit 132 to display and output a video on the display 144 and output sound from the sound output unit 132 of the headphones 130 and then proceed to step S2.

### (Step S2)

In step S2, the control unit 210 determines whether the video data is a moving picture. When the video data is determined as a moving picture (YES), the control unit 210 proceeds to step S3. When the video data is not determined as a moving picture (NO), because gaze detection and gaze prediction are unnecessary, the control unit 210 proceeds to step S7. Also, in the case of a moving picture that requires gaze detection but does not require gaze prediction, the control unit 210 performs gaze prediction to be described below and performs different processing as needed. Here, as described above, whether video data is a moving picture is determined on the basis of whether the video data can serve as a “moving body that a user recognizes.” Therefore, a moving picture such as movement of a person who is simply walking does not have to be an object. Because a type of video data is known, whether video data is a moving picture may also be determined on the basis of whether initial setting has been performed according to the type when reproducing the video data. Also, determining whether video data is a moving picture may include a sliding method in which a plurality of still images are displayed and switched at predetermined timings. Therefore, step S2 may be a determining step of determining, in a scene in which the scene changes, including the case of a normal moving picture, whether video data is a “moving picture in which video in a predetermined area needs to be sharpened.”

### (Step S3)

In step S3, the control unit 210 detects a gaze point (gaze position) of the user P on the display 144 by the gaze detection unit 213 on the basis of image data captured by the camera 146 and specifies a position thereof, and the process proceeds to step S4. Further, in step S3, in specifying the gaze point of the user, for example, when there is a scene change as described above, a portion at which the user gazes may not be specified, that is, movement of the user searching for which point to gaze at (movement in which a gaze moves around) in a screen may be included. Therefore, to help the user find where to gaze at, the resolution of the entire screen may be increased or a predetermined area which has already been set may be released to make the screen easier to view, and then the gaze point may be detected.

### (Step S4)

In step S4, the control unit 210 determines whether the user P is gazing at a specific character. Specifically, when a character is moving or the like in a video changing in a time series, the control unit 210 determines whether the user P is gazing at a specific character by determining whether a change in the X-Y coordinate axis of a detected gaze point changing in the time axis corresponds to the X-Y coordinate axis in the video according to a time table for a predetermined time (e.g., one second) based on an initially specified X-Y coordinate axis. When the user P is determined as gazing at a specific character (YES), the control unit 210 specifies the character at which the user P gazes, and the process proceeds to step S5. When the user P is not determined as gazing at a specific character (NO), the control unit 210 proceeds to step S8. Further, the above specifying order is the same even when the specific character is not moving. For example, like a car race, although one specific machine (or a machine of a specific team) is specified in the entire race, a machine is also specified according to a scene (course) on the display in some cases. That is, in a moving picture of a car race, one specific machine (or a machine of a specific team) is not necessarily present on the screen, and there are various ways to enjoy the moving picture of a car race, such as watching the car race as a whole depending on the scene or watching traveling of a rival team. Therefore, when setting one specific machine (character) is not necessary, this routine may be skipped. Further, detecting a specific gaze point is not limited to the case of eye tracking detection for detecting a gaze position the user is currently viewing. That is, like a case in which a panorama video is displayed on a screen, detecting a specific gaze point may include position tracking (motion tracking) detection in which movement of the head of the user, i.e., a head position such as up-down, left-right rotation or front-rear, left-right tilting, is detected.

### (Step S5)

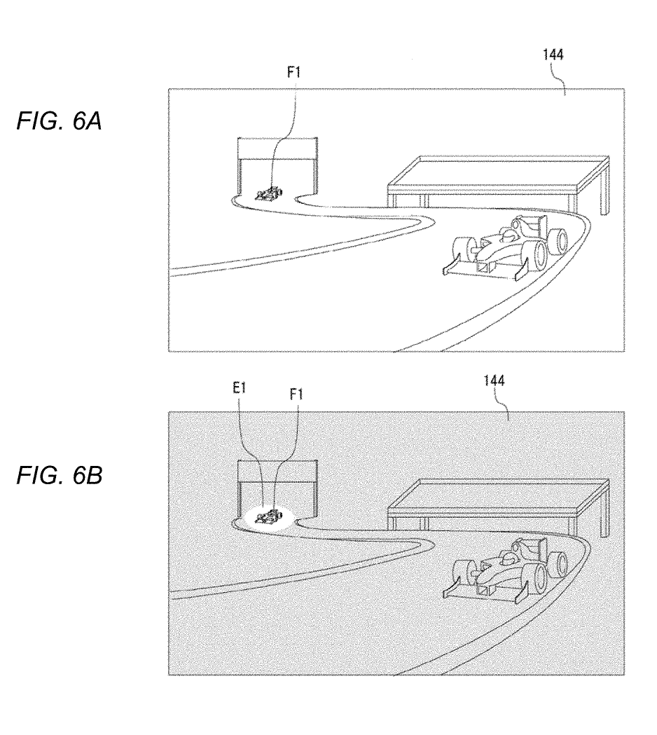

In Step S5, in reality, in parallel with the routine of step S6, the control unit 210 causes the video generation unit 214 to generate new video data so that a person gazed at by the user P can be easily identified and transmits the newly generated video data from the second communication unit 212 to the first communication unit 147, and the process proceeds to step S6. Accordingly, for example, on the display 144, from a general video display state illustrated in FIG. 6(A), as illustrated in FIG. 6(B), surrounding video including a machine F1 as a specific character is set as a predetermined area E1 to be viewed as it is (or with increased resolution), and other areas (of the entire screen) are displayed as blurred video. That is, the video generation unit 214 performs emphasis processing in which video data is newly generated so that video in the predetermined area E1 is easier to gaze at than video in the other areas.

### (Step S6)

In step S6, using the gaze prediction unit 216, the control unit 210 determines whether the specific character (machine F1) is a predictable moving body based on a current gaze position (gaze point) of the user P. When the specific character (machine F1) is determined as a predictable moving body (YES), the control unit 210 proceeds to step S7. When the specific character (machine F1) is not determined as a predictable moving body (NO), the control unit 210 proceeds to step S8. Further, the prediction of a movement destination of the gaze point may be changed, for example, according to contents of the moving picture. Specifically, the prediction may also be performed on the basis of a motion vector of a moving body. Also, when a scene to be gazed at by the user, such as generation of sound or the face of a person, is displayed on the screen, it is highly likely that the gaze will move with respect to a person making such sound or a person whose face is visible. Therefore, a predictable moving body may include a case in which a gaze position is switched from the specific character which is currently being gazed at. Similarly, when the above-described position tracking detection is included, a scene on a line extending from the movement of the head or the whole body may be an object of prediction. Further, for example, when the screen is cut within a certain range as in the above-described race moving picture, that is, when a panorama angle is set, because the user turns his or her head in the reverse direction, the returning may also be included in the prediction.

### (Step S7)

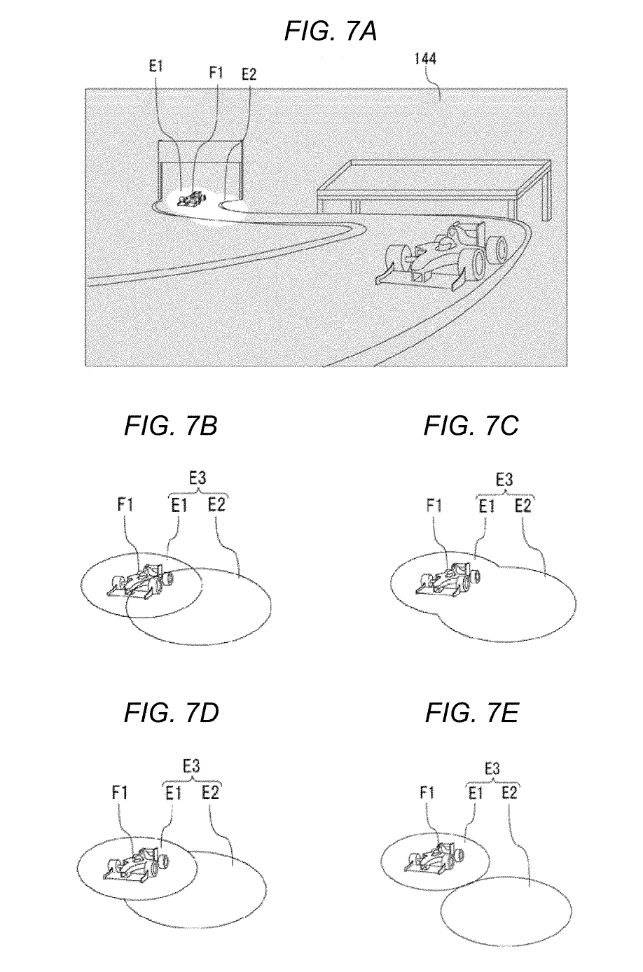

In step S7, using the extension video generation unit 217, as illustrated in FIG. 7A, the control unit 210 sets a predicted area E2 corresponding to a gaze direction predicted by the gaze prediction unit 216 in addition to the video in the predetermined area E1, and performs video processing so that video in the predicted area E2 is recognized better than other areas by the user P, and the process proceeds to step S8. Here, the extension video generation unit 217 sets the predicted area E2 so that surrounding video including at least a part of the specific character (machine F1) is set to be sharper than video in the other areas in a predicted movement direction of the specific character (machine F1) to be adjacent to the predetermined area E1. That is, video displayed by the head mounted display 100 is often set to a low resolution because of the relationship of the data amount when transferring video data. Therefore, by increasing resolution of the predetermined area E1 including the specific character at which the user P gazes and sharpening the predetermined area E1, video can be easily viewed in that portion.

Further, as illustrated in FIG. 7(B), the extension video generation unit 217 sets the predetermined area E1 and the predicted area E2 and then performs video processing so that an extended area E3 in which the predicted area E2 is located in a state in which the predicted area E2 is partially shared with the predetermined area E1 is formed. Accordingly, the predetermined area E1 and the predicted area E2 can be easily set.

Here, the extension video generation unit 217 performs video processing so that the predicted area E2 is larger than an area based on the shape of the predetermined area E1 (in the illustrated example, an ellipse which is long in horizontal direction). Accordingly, when the size displayed on the display 144 increases with movement as in the case in which the specific character is the machine F1, the entire machine F1 can be accurately displayed, and when the machine F1 actually moves, the predicted area E2 may be used as the next predetermined area E1 without change. Further, in FIG. 7(B), frames of the predetermined area E1 and the predicted area E2 is to show the shape, and the frame is not displayed on the display 144 in actual area setting.

Further, as illustrated in FIG. 7(C), the extension video generation unit 217 may perform video processing on a single extended area E3 in which the predetermined area E1 and the predicted area E2 are synthesized. Accordingly, sharpening processing of video processing may be easily performed.

Further, as illustrated in FIG. 7(D), the extension video generation unit 217 may perform video processing on the extended area E3 in a state in which the predicted area E2 of a different shape from the predetermined area E1 does not overlap the predetermined area E1. Accordingly, sharpening of video processing of overlapping parts may be eliminated.

Further, as illustrated in FIG. 7(E), the extension video generation unit 217 may merely adjoin the predetermined area E1 and the predicted area E2. The shape, size, or the like of each area is arbitrary.

### (Step S8)

In step S8, the control unit 210 determines whether reproduction of video data is ended. When generation of video data is determined as having been ended (YES), the control unit 210 ends the routine. When generation of video data is not determined as having been ended (NO), the control unit 210 loops to step S3 and then repeats each of the above routines until reproduction of the video data ends. Therefore, when the user P wants to gaze at a video output in an emphasized state, it is not determined that a specific character is being gazed at just by stopping gazing at a specific person who was being gazed at (NO to step S3), and emphasized display is stopped. Further, in the above described step S2, when the control unit 210 has determined whether video data is a moving picture in which video in a predetermined area needs to be sharpened instead of determining whether video data is a moving picture, the process may loop to step S2, instead of step S3, to form a predetermined area and perform gaze prediction for the next scene or the like.

However, when a character moving in the screen is present in video being output from the display 144 in the gaze direction of the user P detected by the gaze detection unit 213, the video display system 1 may specify the character and cause an output state of sound (including playing an instrument) output from the sound output unit 132 corresponding to the specified character to be different from an output state of another sound, and generate sound data so that the user can identify the character.

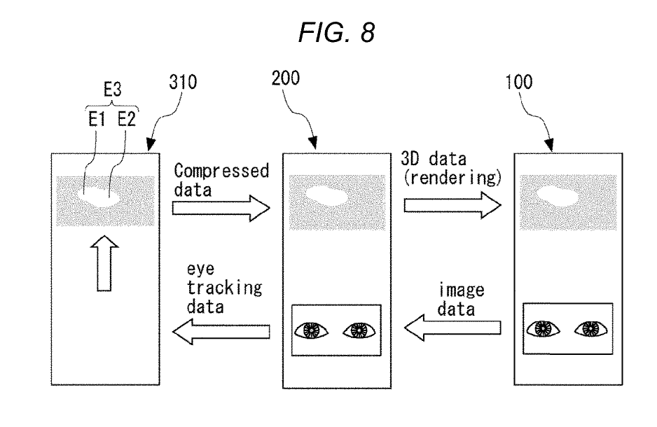

FIG. 8 is an explanatory diagram of an example of downloading video data from the server 310 and displaying the video on the display 144 in the above described video display system 1. As illustrated in FIG. 8, image data for detecting a current gaze of the user P is transmitted from the head mounted display 100 to the gaze detection device 200. The gaze detection device 200 detects a gaze position of the user P on the basis of the image data and transmits gaze detection data to the server 310. The server 310 generates compressed data including the extended area E3 in which the predetermined area E1 and the predicted area E2 are synthesized in the downloaded video data on the basis of the gaze detection data and transmits the compressed data to the gaze detection device 200. The gaze detection device 200 generates (renders) a 3D stereoscopic image on the basis of the compressed data and transmits the 3D stereoscopic image to the head mounted display 100. By sequentially repeating the above, the user P may easily view desired video. When a 3D stereoscopic image is transmitted from the gaze detection device 200 to the head mounted display 100, for example, a High Definition Multimedia Interface (HDMI, registered trademark) cable may be used. Therefore, functions of the extension video generation unit may be divided into the function of the server 310 (generating compressed data) and the function of the extension video generation unit 217 (rendering 3D stereoscopic video data of the gaze detection device 200. Similarly, the functions of the extension video generation unit may be entirely performed by the server 310 or the gaze detection device 200.

### <Supplement>

The video display system 1 is not limited to the above embodiment and may also be realized using other methods. Hereinafter, other embodiments will be described.

(1) Although the above embodiment has been described on the basis of an actually captured video, the above embodiment may also be applied to a case in which a pseudo-person or the like is displayed in a virtual reality space.

(2) In the above embodiment, although video reflected from the wavelength control member 145 is captured as a method of capturing an image of the eye of the user P to detect a gaze of the user P, the image of the eye of the user P may be directly captured without passing through the wavelength control member 145.

(3) The method related to gaze detection in the above embodiment is merely an example, and a gaze detection method by the head mounted display 100 and the gaze detection device 200 is not limited thereto.

First, although an example in which a plurality of near-infrared light irradiation units that emit near-infrared light as invisible light is given, a method of irradiating the eye of the user P with near-infrared light is not limited thereto. For example, each pixel that constitutes the display 144 of the head mounted display 100 may include sub-pixels that emit near-infrared light, and the sub-pixels that emit near-infrared light may be caused to selectively emit light to irradiate the eye of the user P with near-infrared light. Alternatively, the head mounted display 100 include a retinal projection display instead of the display 144 and realize near-infrared irradiation by displaying using the retinal projection display and including pixels that emit a near-infrared light color in the video projected to the retina of the user P. Sub-pixels that emit near-infrared light may be regularly changed for both the display 144 and the retinal projection display.

Further, the gaze detection algorithm is not limited to the method given in the above-described embodiment, and other algorithms may be used as long as gaze detection can be realized.

(4) In the above embodiment, an example in which, when video output by the display 144 is a moving picture, movement of a specific character is predicted depending on whether a character at which the user P has gazed for a predetermined time or more is present is given. In the processing, the processing below may be added. That is, an image of the eye of the user P is captured using the imaging unit 154, and the gaze detection device 200 specifies movement of the pupil of the user P (change in an open state). The gaze detection device 200 may include an emotion specifying unit that specifies an emotion of the user P according to the open state of the pupil. Further, the video generation unit 214 may change the shape or size of each area according to the emotion specified by the emotion specifying unit. More specifically, for example, when the pupil of the user P widely opens when a certain machine overtakes another machine, the movement of the machine viewed by the user P may be determined as special, and it can be estimated that the user P is interested in the machine. Similarly, the video generation unit 214 may change to further emphasize (for example, darken the surrounding blur) the emphasis of video at that time.

(5) In the above embodiment, changing a display form such as emphasizing by the video generation unit 214 is simultaneously performed with changing a sound form by the sound generation unit 215. However, for changing a display form, for example, switching to a commercial message (CM) video for selling a product related to a machine being gazed at or other videos online may occur.

(6) Although the gaze prediction unit 216 has been described in the above embodiment as predicting subsequent movement of a specific character as an object, the gaze of the user P may be predicted to move when the change amount of a brightness level in the video output by the display 144 is a predetermined value or larger. Therefore, a predetermined range including a pixel in which a change amount of a brightness level between a frame of a display object in video and a subsequent frame displayed after the frame is the predetermined value or larger may be specified as a predicted area. Further, when the change amount of the brightness level between the frames is the predetermined value or larger in multiple spots, a predetermined range including a spot closest to a detected gaze position may be specified as a predicted area. Specifically, it can be assumed that a new moving body enters a frame (is frame-in) on the display 144 while specifying the predetermined area E1 by detecting a gaze of the user P. That is, because a brightness level of the new moving body may be higher than the brightness level of the same portion before the new moving body is frame-in, it is likely that the gaze of the user P also aims the new moving body. Therefore, when there is such a newly framed-in moving body, the type or the like of the moving body may be easily identified when the moving body is made easy to view. Such gaze guiding gaze prediction is particularly useful for moving pictures of games such as shooting games.

(7) Although processors of the head mounted display 100 and the gaze detection device 200 realize the video display system 1 by executing programs and the like according to the above embodiment, the video display system 1 may also be realized by a logic circuit (hardware) or a dedicated circuit formed in an integrated circuit (IC) chip, a large scale integration (LSI), or the like of the gaze detection device 200. These circuits may be realized by one or a plurality of ICs, and functions of a plurality of functional parts in the above embodiment may be realized by a single IC. The LSI is sometimes referred to as VLSI, super LSI, ultra LSI, etc. due to the difference in integration degree.

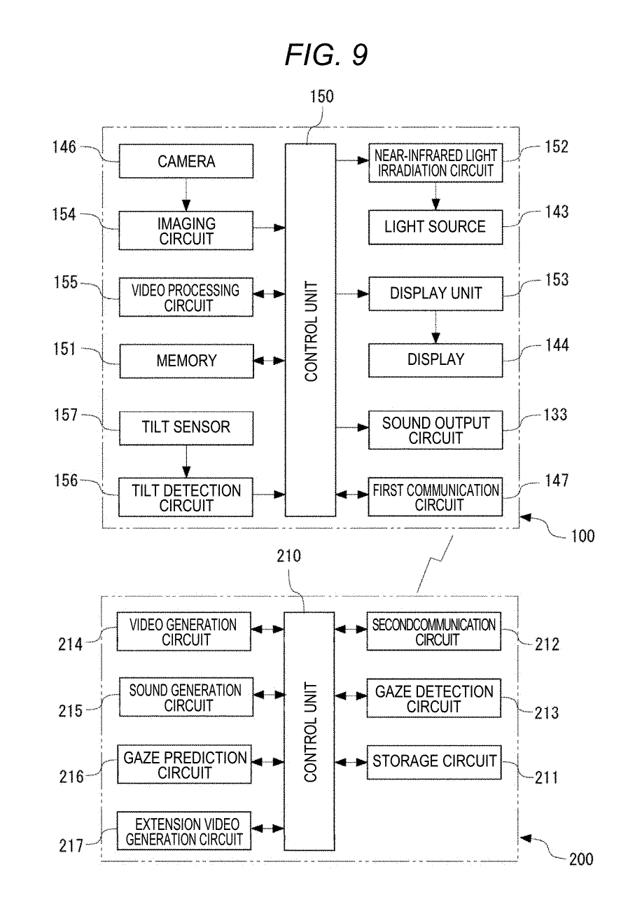

That is, as illustrated in FIG. 9, the head mounted display 100 may include a sound output circuit 133, a first communication unit 147, a control circuit 150, a memory circuit 151, a near-infrared light irradiation circuit 152, a display circuit 153, an imaging circuit 154, an image processing circuit 155, and a tilt detection circuit 156, and functions thereof are the same as those of respective parts with the same names given in the above embodiment. Further, the gaze detection device 200 may include a control circuit 210, a second communication circuit 212, a gaze detection circuit 213, a video generation circuit 214, a sound generation circuit 215, a gaze prediction circuit 216, and an extension video generation circuit 217, and functions thereof are the same as those of respective parts with the same names given in the above embodiment.

The video display program may be recorded in a processor-readable recording medium, and a “non-transient tangible medium” such as a tape, a disc, a card, a semiconductor memory, and a programmable logic circuit may be used as the recording medium. Further, a retrieval program may be supplied to the processor via any transmission medium (a communication network, broadcast waves, or the like) capable of transferring the retrieval program. The present invention can also be realized in the form of a data signal embedded in carrier waves in which the video display program is implemented by electronic transmission.

The gaze detection program may be implemented using, for example, a script language such as ActionScript, JavaScript (registered trademark), Python, or Ruby and a compiler language such as C language, C++, C#, Objective-C, or Java (registered trademark).

(8) The configurations given in the above embodiment and each (supplement) may be appropriately combined.

By displaying video in a state in which the video can be easily viewed by a user in a video display system that displays video on a display, the present invention can improve convenience of the user and is generally applicable to a video display system that displays video on a display while being worn by a user, a video display method, and a video display program.

1. A video display system comprising:
a video output unit that outputs a video;
a gaze detection unit that detects a gaze direction of a user on the video output by the video output unit;
a video generation unit that performs video processing so that the user recognizes the video in a predetermined area corresponding to the gaze direction detected by the gaze detection unit better than other areas in the video output by the video output unit;
a gaze prediction unit that predicts moving direction of the gaze of the user when the video output by the video output unit is a moving picture; and
an extension video generation unit that performs video processing so that, in addition to the video in the predetermined area, the user recognizes the video in a predicted area corresponding to the gaze direction predicted by the gaze prediction unit better than other areas when the video output by the video output unit is a moving picture.

2. The video display system according to claim 1, wherein the extension video generation unit performs video processing so that the predicted area is located adjacent to the predetermined area.

3. The video display system according to claim 1, wherein the extension video generation unit performs video processing so that the predicted area is located in a state in which the predicted area is partially shared with the predetermined area.

4. The video display system according to claim 1, wherein the extension video generation unit performs video processing so that the predicted area is larger than an area based on a shape of the predetermined area.

5. The video display system according to claim 1, wherein the extension video generation unit performs video processing with the predetermined area and the predicted area as a single extended area.

6. The video display system according to claim 1, wherein the gaze prediction unit predicts the gaze of the user on the basis of video data corresponding to a moving body that the user recognizes in the video data of the video output by the video output unit.

7. The video display system according to claim 1, wherein the gaze prediction unit predicts the gaze of the user on the basis of accumulated data that varies in past time-series with respect to the video output by the video output unit.

8. The video display system according to claim 1, wherein the gaze prediction unit predicts that the gaze of the user will move when a change amount of a brightness level in the video output by the video output unit is a predetermined value or larger.

9. The video display system according to claim 1, wherein the video output unit is arranged in a head mounted display that is worn on the head of the user.

10. A video display method comprising:
a video outputting step of outputting a video,
a gaze detecting step of detecting a gaze direction of a user on the video output in the video outputting step;
a video generating step of performing video processing so that the user recognizes the video in a predetermined area corresponding to the gaze direction detected in the gaze detecting step better than other areas in the video output in the video outputting step;
a gaze predicting step of predicting a moving direction of the gaze of the user when the video output in the video outputting step is a moving picture, and
an extended area video generating step of performing video processing so that, in addition to the video in the predetermined area, the user recognizes the video in a predicted area corresponding to the gaze direction predicted in the gaze predicting step better than other areas when the video output in the video outputting step is a moving picture.

11. A video display program that allows a computer to execute:
a video outputting function of outputting a video;
a gaze detecting function of detecting a gaze direction of a user on the video output by the video outputting function;
a video generating function of performing video processing so that the user recognizes the video in a predetermined area corresponding to the gaze direction detected in the gaze detecting step better than other areas in the video output by the video outputting function;
a gaze predicting function of predicting a moving direction of the gaze of the user when the video output in the video outputting step is a moving picture; and
an extended area video generating function of performing video processing so that, in addition to the video in the predetermined area, the user recognizes the video in a predicted area corresponding to the gaze direction predicted by the gaze predicting function better than other areas when the video output by the video outputting function is a moving picture.
